(19) United States
(12) Patent Application Publication
(10) Pub. No.: US 2024/0349319 A1
(43) Pub. Date: Oct. 17, 2024

(54) TXOP PREEMPTION FOR LOW LATENCY APPLICATION

(71) Applicants: Juan Fang, Portland, OR (US); Laurent Cariou, Milizac (FR)

(72) Inventors: Juan Fang, Portland, OR (US); Laurent Cariou, Milizac (FR)

(21) Appl. No.: 18/757,086

(22) Filed: Jun. 27, 2024

Related U.S. Application Data
(60) Provisional application No. 63/512,548, filed on Jul. 7, 2023.

(51) Int. Cl. H04W 72/512; H04L 5/00; H04W 72/566

(52) U.S. Cl. CPC H04W 72/512; H04L 5/0007; H04W 72/569

(57) ABSTRACT

Methods, apparatuses, and computer readable media for transmission opportunity (TxOP) preemption for low latency applications, where a station (STA) comprises processing circuitry configured to: decode, from an access point (AP), a frame, wait for a preemption duration, the preemption duration less than a wait duration of the AP, and in response to a determination that a medium is idle during the preemption duration and that the STA has pending low-latency (LL) data to send to the AP, encode, for transmission to the AP after the preemption duration an indication of a preemption request (PR).

### PRIORITY CLAIM

This application claims the benefit of priority under 35 USC 119 (e) to U.S. Provisional Patent Application Ser. No. 63/512,548, filed Jul. 7, 2023, which is incorporated herein by reference in its entirety.

### TECHNICAL FIELD

Embodiments relate to transmission opportunity (TXOP) preemption for low-latency (LL) applications, in accordance with wireless local area networks (WLANs) and Wi-Fi networks including networks operating in accordance with different versions or generations of the IEEE 802.11 family of standards.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols on different bands and on different channels.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates a front-end module circuitry for use in the radio architecture of FIG. 1 in accordance with some embodiments;

FIG. 3 illustrates a radio IC circuitry for use in the radio architecture of FIG. 1 in accordance with some embodiments;

FIG. 4 illustrates a baseband processing circuitry for use in the radio architecture of FIG. 1 in accordance with some embodiments;

FIG. 5 illustrates a WLAN in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates multi-link devices (MLD)s, in accordance with some embodiments;

FIG. 9 illustrates a method for TXOP preemption for LL applications, in accordance with some embodiments.

FIG. 10 illustrates a method for TXOP preemption for LL applications, in accordance with some embodiments.

FIG. 11 illustrates a method for TXOP preemption for LL applications, in accordance with some embodiments.

FIG. 12 illustrates a method for TXOP preemption for LL applications, in accordance with some embodiments.

FIG. 13 illustrates a method for TXOP preemption for LL applications, in accordance with some embodiments.

FIG. 14 illustrates a method for TXOP preemption for LL applications, in accordance with some embodiments.

FIG. 15 illustrates a method for TXOP preemption for LL applications, in accordance with some embodiments.

FIG. 16 illustrates a method for TXOP preemption for LL applications, in accordance with some embodiments.

FIG. 17 illustrates a method for TXOP preemption for LL applications, in accordance with some embodiments.

FIG. 18 illustrates a method for TXOP preemption for LL applications, in accordance with some embodiments.

FIG. 19 illustrates a method for TXOP preemption for LL applications, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth® (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth® (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth® (BT) connectivity standard such as Bluetooth®, Bluetooth® 4.0 or Bluetooth® 5.0, or any other iteration of the Bluetooth® Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about nine hundred MHz, 2.4 GHZ, 5 GHZ, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

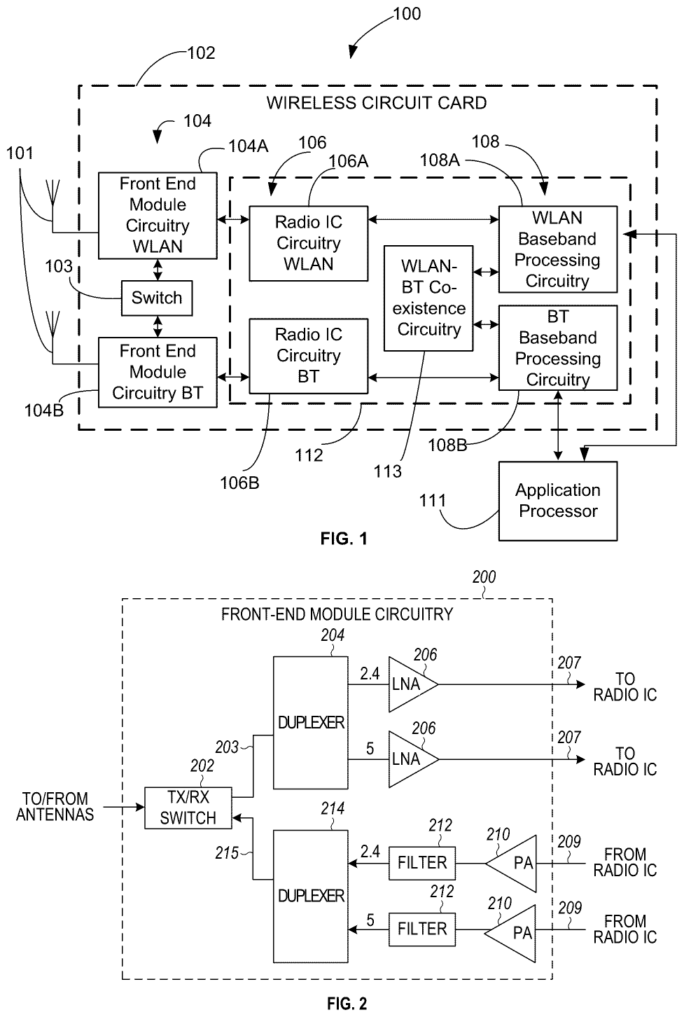

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

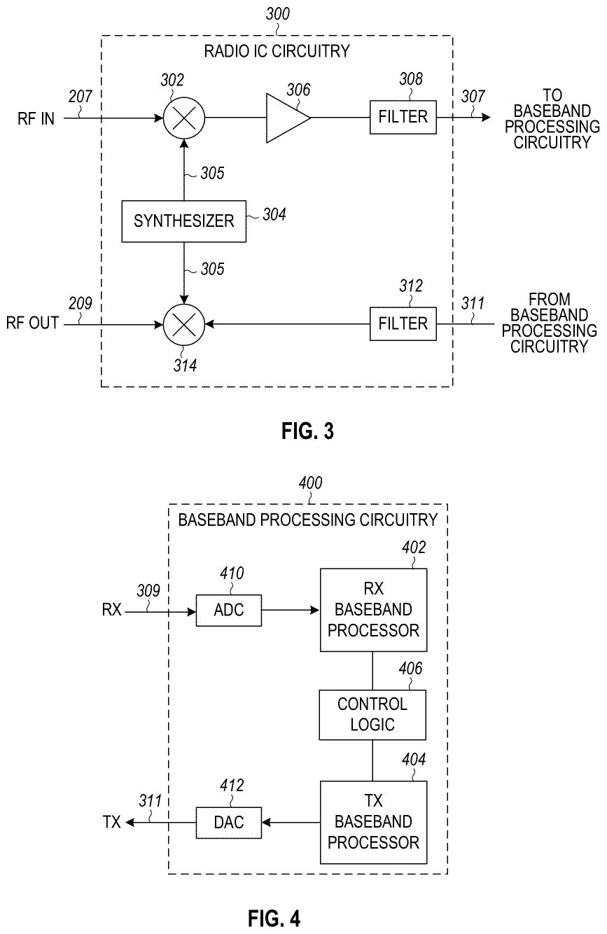

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

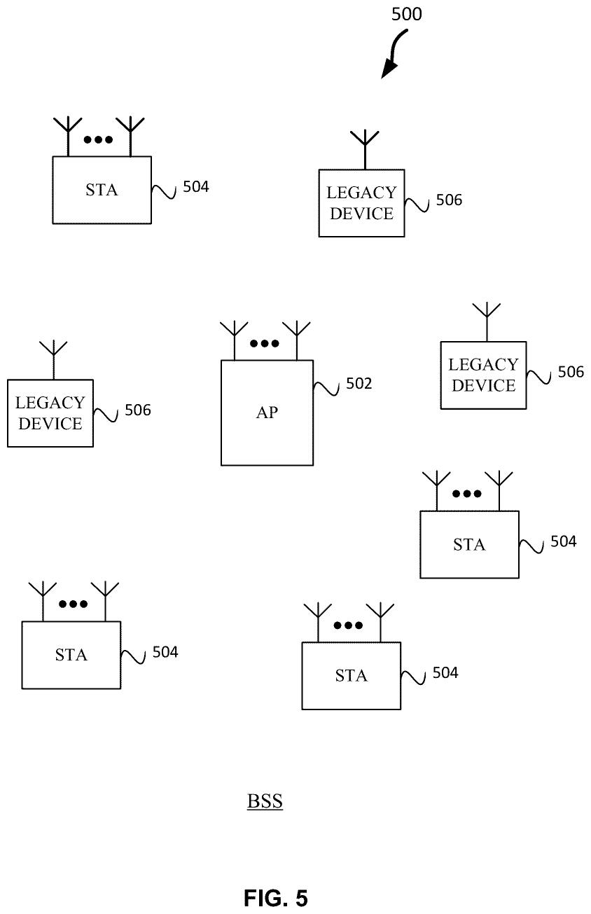

FIG. 5 illustrates a WLAN 500 in accordance with some embodiments. The WLAN 500 may comprise a basis service set (BSS) that may include an access point (AP) AP 502, a plurality of stations (STAs) STAs 504, and a plurality of legacy devices 506. In some embodiments, the STAs 504 and/or AP 502 are configured to operate in accordance with IEEE 802.11be extremely high throughput (EHT), WiFi 8 IEEE 802.11 ultra-high throughput (UHT), high efficiency (HE) IEEE 802.11ax, IEEE 802.11bn next generation or ultra-high reliability (UHR), and/or another IEEE 802.11 wireless communication standard. In some embodiments, the STAs 504 and/or AP 502 are configured to operate in accordance with IEEE P802.11be, and/or IEEE P802.11-REVme™, both of which are hereby included by reference in their entirety.

The AP 502 may use other communications protocols as well as the IEEE 802.11 protocol. The terms here may be termed differently in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax/uht, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the AP 502 may also be configured to communicate with STAs 504 in accordance with legacy IEEE 802.11 communication techniques.

In some embodiments, a HE, EHT, UHT frames may be configurable to have the same bandwidth as a channel. The HE, EHT, UHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, downlink (DL) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2x996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE, EHT, UHT, UHT, or UHR frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11EHT/ax/bc embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE, EHT, UHR control period, the AP 502 may communicate with STAs 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer or wait from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/UHR communication techniques, although this is not a requirement.

In some embodiments the STA 504 may be a “group owner” (GO) for peer-to-peer modes of operation. A wireless device may be a STA 504 or a HE AP 502. The STA 504 may be termed a non-access point (AP) (non-AP) STA 504, in accordance with some embodiments.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

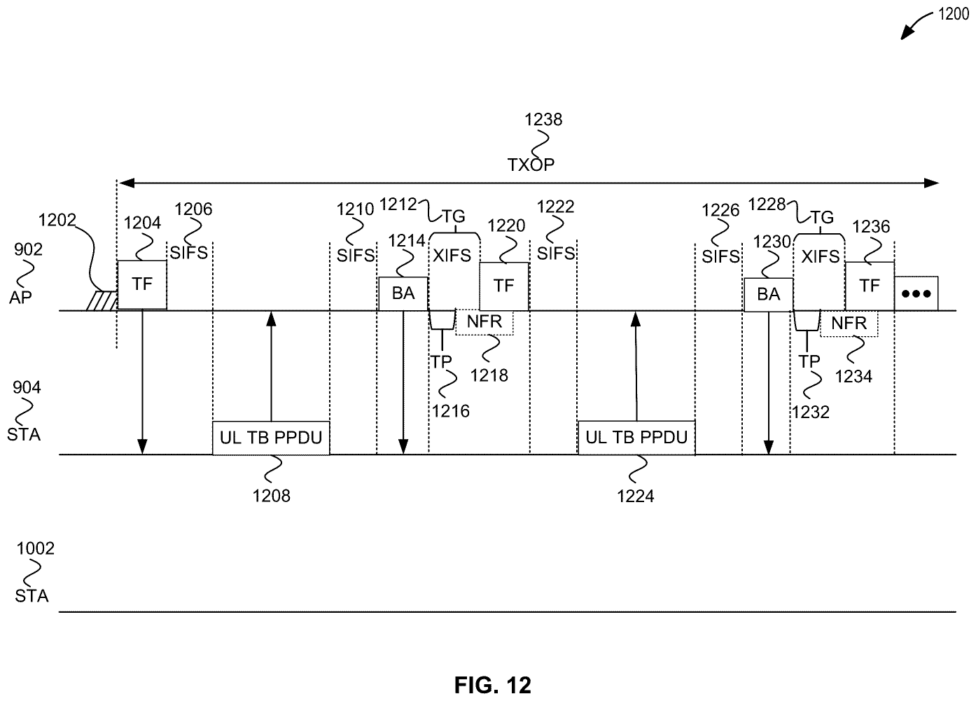

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-19.

In example embodiments, the STAs 504 and/or the AP 502 are configured to perform the methods and operations/functions described herein in conjunction with FIGS. 1-19. In example embodiments, an apparatus of the STA 504 and/or an apparatus of the AP 502 are configured to perform the methods and functions described herein in conjunction with FIGS. 1-19. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP. The AP 502 may be part of, or affiliated with, an AP MLD 808, e.g., AP1 830, AP2 832, or AP3 834. The STAs 504 may be part of, or affiliated with, a non-AP MLD 809, which may be termed a ML non-AP logical entity. The BSS may be part of an extended service set (ESS), which may include multiple APs, access to the internet, and may include one or more management devices.

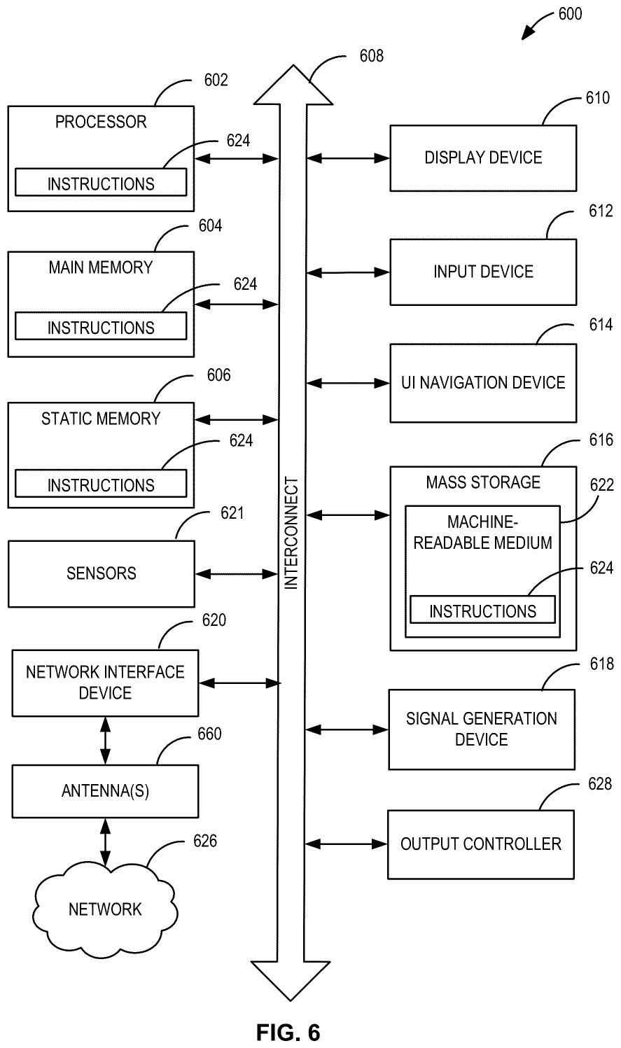

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT STA 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The mass storage 616 device may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage 616 device may constitute machine readable media.

Specific examples of machine-readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

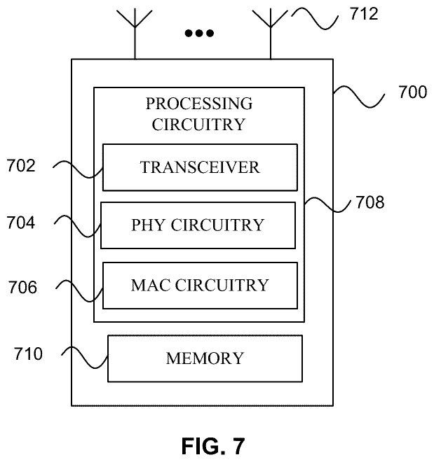

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mm Wave technology, communication between a station (e.g., the HE STAs 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

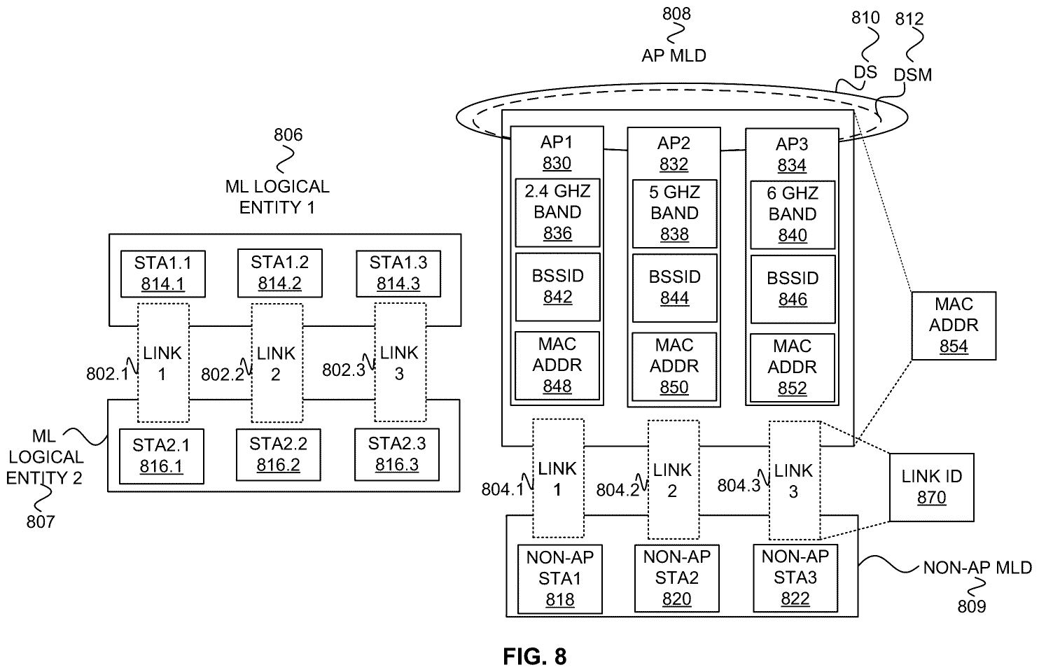

FIG. 8 illustrates multi-link devices (MLD) s 800, in accordance with some embodiments. Illustrated in FIG. 8 is ML logical entity 1 806, ML logical entity 2 807, AP MLD 808, and non-AP MLD 809. The ML logical entity 1 806 includes three STAs, STA1.1 814.1, STA1.2 814.2, and STA1.3 814.3 that operate in accordance with link 1 802.1, link 2 802.2, and link 3 802.3, respectively.

The Links are different frequency bands such as 2.4 GHz band, 5 GHz band, 6 GHZ band, and so forth. ML logical entity 2 807 includes STA2.1 816.1, STA2.2 816.2, and STA2.3 816.3 that operate in accordance with link 1 802.1, link 2 802.2, and link 3 802.3, respectively. In some embodiments ML logical entity 1 806 and ML logical entity 2 807 operate in accordance with a mesh network. Using three links enables the ML logical entity 1 806 and ML logical entity 2 807 to operate using a greater bandwidth and more reliably as they can switch to using a different link if there is interference or if one link is superior due to operating conditions.

The distribution system (DS) 810 indicates how communications are distributed and the DS medium (DSM) 812 indicates the medium that is used for the DS 810, which in this case is the wireless spectrum.

AP MLD 808 includes AP1 830, AP2 832, and AP3 834 operating on link 1 804.1, link 2 804.2, and link 3 804.3, respectively. AP MLD 808 includes a MAC ADDR 854 that may be used by applications to transmit and receive data across one or more of AP1 830, AP2 832, and AP3 834. Each link may have an associated link ID. For example, as illustrated, link 3 804.3 has a link ID 870.

AP1 830, AP2 832, and AP3 834 includes a frequency band, which are 2.4 GHz band 836, 5 GHz band 838, and 6 GHz band 840, respectively. AP1 830, AP2 832, and AP3 834 includes different BSSIDs, which are BSSID 842, BSSID 844, and BSSID 846, respectively. AP1 830, AP2 832, and AP3 834 includes different media access control (MAC) address (addr), which are MAC adder 848, MAC addr 850, and MAC addr 852, respectively. The AP 502 is a AP MLD 808, in accordance with some embodiments. The STA 504 is a non-AP MLD 809, in accordance with some embodiments.

The non-AP MLD 809 includes non-AP STA1 818, non-AP STA2 820, and non-AP STA3 822. Each of the non-AP STAs may have MAC addresses and the non-AP MLD 809 may have a MAC address that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as ML logical entity 1 806 or ML logical entity 2 807, is a logical entity that contains one or more STAs 814, 816. The ML logical entity 1 806 and ML logical entity 2 807 each has one MAC data service interface and primitives to the logical link control (LLC) and a single address associated with the interface, which can be used to communicate on the DSM 812. Multi-link logical entity allows STAs 814, 816 within the multi-link logical entity to have the same MAC address. In some embodiments a same MAC address is used for application layers and a different MAC address is used per link.

In infrastructure framework, AP MLD 808, includes APs 830, 832, 834, on one side, and non-AP MLD 809, which includes non-APs STAs 818, 820, 822 on the other side.

ML AP device (AP MLD): is a ML logical entity, where each STA within the multi-link logical entity is an EHT AP 502, in accordance with some embodiments. ML non-AP device (non-AP MLD) A multi-link logical entity, where each STA within the multi-link logical entity is a non-AP EHT STA 504. AP1 830, AP2 832, and AP3 834 may be operating on different bands and there may be fewer or more APs. There may be fewer or more STAs as part of the non-AP MLD 809.

In some embodiments the AP MLD 808 is termed an AP MLD or MLD. In some embodiments non-AP MLD 809 is termed a MLD or a non-AP MLD. Each AP (e.g., AP1 830, AP2 832, and AP3 834) of the MLD sends a beacon frame that includes: a description of its capabilities, operation elements, a basic description of the other AP of the same MLD that are collocated, which may be a report in a Reduced Neighbor Report element or another element such as a basic multi-link element. AP1 830, AP2 832, and AP3 834 transmitting information about the other APs in beacons and probe response frames enables STAs of non-AP MLDs to discover the APs of the AP MLD.

In a Wi-Fi network or IEEE 802.11 network, “channel switching” refers to a method where the AP 502 in an infrastructure networks or Group Owner (GO) in peer-to-peer networks determines to transition from a current channel to a new target channel. The AP 502 may determine to switch channels for lots of reasons such as interference.

During channel switching, the clients such as STAs 504 and legacy devices 506 that are associated with the AP 502 on an old channel or original channel often remain associated with the AP 502 on the new channel. The clients are expected to move alongside the GO or AP 502 and maintain uninterrupted communication as if they were still operating on the original channel. The continues uninterrupted communication includes preserving sequence numbers of PPDUs and other relevant contexts.

However, Wi-Fi or IEEE 802.11 bands do not uniformly follow the same rules in terms of the allowed formats and bandwidths that clients can use. For example, in the 2.4 GHz band, a client can utilize the HT format with a bandwidth of 20/40 MHz. In the 5 GHz band, a client can use HT/VHT and HE formats with bandwidths of 20/40/80/160 MHz. In the 6 GHz band, a client is mandated to use HE or EHT (Wi-Fi-7) and can transmit frames using a 320 MHz bandwidth.

Clients associate with APs 502. During the association process, the clients and APs 502 exchange capabilities through an association request frame and an association response frame. The AP 502 may move to another band or target channel and the AP 502 does not know the capabilities of its clients in the target channel. The AP 502 uses the lowest common denominator of client capabilities to communicate with the clients on the target channel, which may be using an HT format, which, often, fails to fully exploit the enhanced potential of the new target band.

In some embodiments, an AP 502 limits the size of TXOPs to permit for LL applications to gain access to the wireless medium and transmit DL and/or UL LL frames. However, limiting the size of a TXOP to “T” ms where T is based on the response needs of the LL services, reduces the overall channel efficiency (MAC and PHY), which may cause delays in providing other services to the wireless devices and users of the wireless devices.

A technical problem is how to enable low-latency applications such as voice over internet protocol (VOIP) to acquire the resources necessary to provide services to users while avoiding lessening the reduction in the overall efficiency of the use of the wireless medium.

In some embodiments, the technical problem is addressed by providing LL STAs the ability to request service during a TxOP. The LL STAs may request service by having a lower wait time than the AP 502 or TxOP holder. The LL STAs can then transmit a generic request for service. The AP 502 may then terminate the TxOP or interrupt the TxOP to provide the LL STAs UL resource units. In some embodiments, dedicated resource units are provided in multi-user frames or multi-user response. A LL STA may then transmit a generic response to indicate a request for service. In some example, the LL STAs may include an indication of their buffer status in the UL frame sent to the AP.

The methods disclosed herein may reduce both the average and the worst-case latency for LL applications in Wi-Fi networks while all the operation channels are being occupied with long TXOP data transmission by other STAs within the BSS with a smaller performance impact to the high throughput traffic.

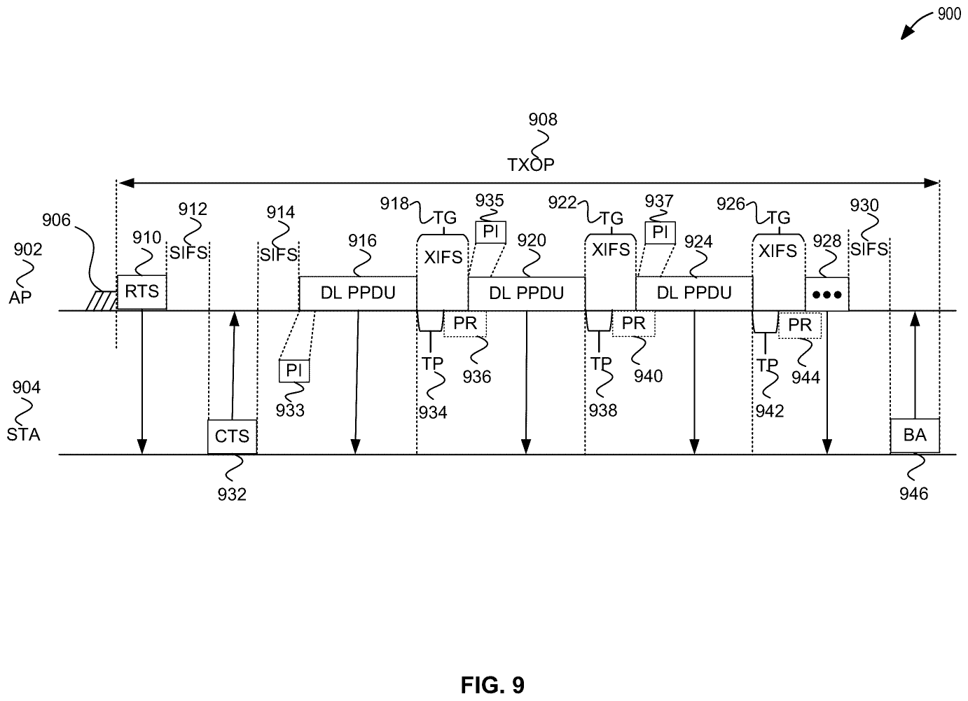

FIG. 9 illustrates a method 900 for TXOP 908 preemption for LL applications, in accordance with some embodiments. The method 900 begins with the AP 902 gaining access to the wireless medium at 906. In some embodiments, larger or large PPDUs broken into smaller PPDUs, DL PPDU 916, DL PPDU 920, and DL PPDU 924, with a maximum length limitation. Time gaps for LL applications (TL) are inserted between the smaller PPDUs to enable a preemption opportunity for LL transmitters such as STA 904. AP 902 is an AP 502 or an AP of an AP MLD 808, in accordance with some embodiments. STA 904 is a STA 504 or a STA of a non-AP MLD 809, in accordance with some embodiments.

One or more LL transmitters, such as STA 904, can start to send a common preemption request (PR), PR 936, PR 940, PR 944, during the time gaps (TG), TG 918, TG 922, TG 926, to indicate that the LL transmitter has an LL packet to send.

This can avoid collision between multiple LL transmitters and also avoid reserving time slots periodically within TXOP for LL traffic. The PR 936, 940, 944, frames can be a short control frames with a receiver address of the AP 902. For example, PR 936, PR 940, and PR 944 may be similar to a CTS frame or a short common waveform, which can be transmitted within TG before the next PPDU. TG 918, 922, 926, is an XIFS duration, which may be one of several different durations, in accordance with some examples.

To differentiate which time gap within the TXOP is preemptable or not a preemption indications (PI) such as PI 933, PI 935, and PI 937 are used in the PPDU, DL PPDU 916, DL PPDU 920, and DL PPDU 924, respectively, preceding the time gap, TG 918, TG 922, and TG 926, respectively. Etcetera 928 indicates the method 900 may continue for the duration of the TXOP 908.

One bit, TP 934, 938, 942, in a universal (U) signal (SIG) (U-SIG) field or an ultra-high reliable (UHR) SIG field of the preceding PPDU will indicate whether preemption is allowed after the end of the preceding PPDU. In some examples, the indication of that preemption is permitted may be indicated in a different way such as in a beacon frame, in trigger frame, a reassociation response frame, a request-to-send frame, a trigger frame, or a multi-user request to send frame, signal field, a ultra-high reliability (UHR) signal field, an universal signal field, or in a different way.

The LL transmitter, STA 904, uses a duration, TP 934, TP 938, and TP 942, that is shorter than the xIFS used by TG 918, TG 922, and TG 926, respectively, to contend for access to the channel and then send a PR 936, 940, 944.

Non LL transmitters use a duration of TG for channel access, which here is xIFS for the TXOP holder to send data, a trigger frame, block acknowledgement or another frame. Different values for TG 918, 922, 926, and TP 934, 938, 942 may be used but TP is less than TG. In some examples, the PR 936, 940, 944, frames are common frames so if multipole LL transmitters transmit the PR 936, 940, 944 frames simultaneous, they will not interfere with one another.

PR 936, 940, 944 frames can only be sent before the next PPDU sent by the AP to avoid hidden node problem between STAs, which means STA cannot preempt STA directly. Upon the reception of the common PR 936, 940, 944, AP 502 may use the following different methods to support the subsequent LL packet transmission. The AP 502 can trigger the LL STAs, e.g., STA 904, to feedback their LL buffer status using a null data packet (NDP) feedback report poll (NFRP), and then the AP 902 can trigger the LL data transmissions in accordance with the results of the NFRP, in accordance with some embodiments. The AP 902 can trigger the LL STAs to send LL packets with uplink OFDMA-based random access, in accordance with some embodiments. The AP 902 can terminate the TXOP 908 and release the channel for LL transmission with EDCA, in accordance with some embodiments. The AP 902 can terminate the TXOP 908 early to accommodate the LL packets, in accordance with some embodiments. In some embodiments, the AP 902 can determine whether the remaining duration of the TXOP 908 by comparing with a response time needed for LL packets indicated within the TXOP 908 should be terminated or completed. In some embodiments, the AP 902 may interrupt the TXOP 908 and then continue the TXOP 908 after accommodate the LL packets.

In some embodiments, the first control frame, such as the RTS 910 frame of the TXOP 908 will indicate whether preemption is allowed or not within the TXOP 908. In some embodiments, the Maximum PPDU length will be indicated and updated in the beacon frames, other management frames, or other frames sent by the AP 902. Method 900 includes RTS 910, SIFS 912, CTS 932, SIFS 914, DL PPDU 916, TG 918, DL PPDU 920, TG 922, DL PPDU 924, TG 926, SIFS 930, and BA 946.

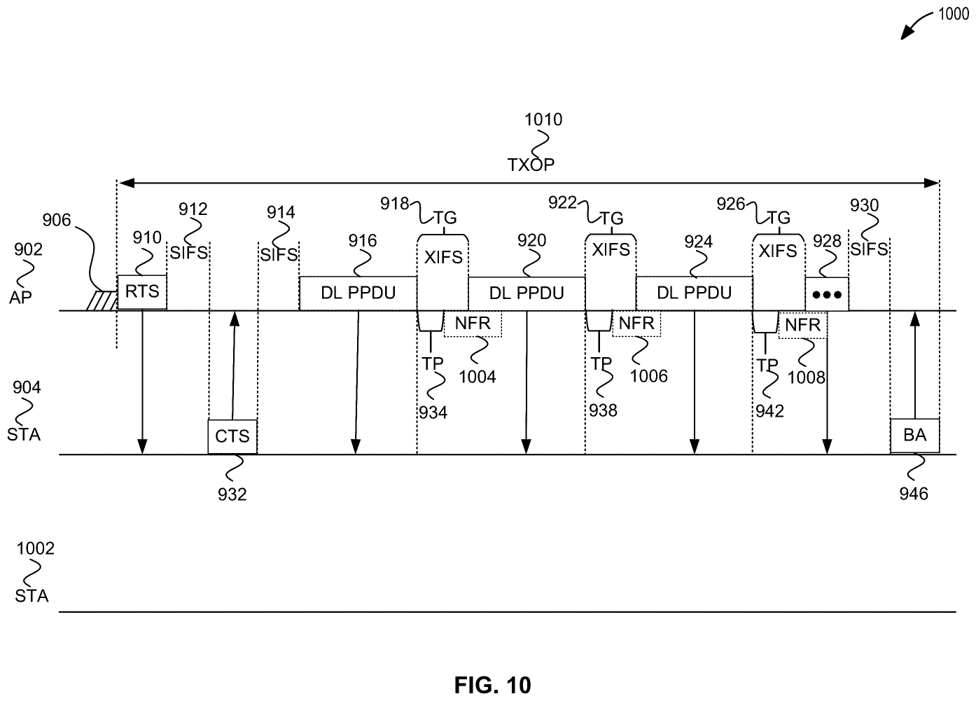

FIG. 10 illustrates a method 1000 for TXOP 1010 preemption for LL applications, in accordance with some embodiments. Large PPDU are broken down into smaller PPDUs, DL PPDU 916, DL PPDU 920, and DL PPDU 924, with a maximum length limitation and time gaps to enable preemption opportunity for LL transmitters, e.g., STA 904, STA 1002.

One or more LL transmitters can indicate that it has LL packet to send by sending NDP Feedback Report (NFR), NFR 1004, NFR 1006, NFR 1008, over the assigned tone set during the time gaps when the preemption is allowed. The tone sets can be assigned in a previous frame such as trigger frame, beacon, NFR trigger frame, a preceding PPDU, or another frame.

The NFRs enable each LL STA 504, e.g., STA 904 and STA 1002, to be assigned different tones to transmit an indication of LL traffic, which can avoid collisions between or among multiple LL transmitters and also avoid reserving a time slot periodically within the TXOP 908 for LL traffic. The tone set information is preassigned to all the registered LL transmitters or integrated in the preceding PPDU such as DL PPDU 916, DL PPDU 920, and DL PPDU 924.

To differentiate which time gap within the TXOP is preemptable or not, a preemption indication is used which may be a field in a PPDU preceding the time gap. In some embodiments, one bit in a universal signal (U-SIG) field or ultra-high reliability SIG (UHR) field of the preceding PPDU will indicate whether preemption is allowed TP 934, 938, 942 after the end of the preceding PPDU, DL PPDU 916, DL PPDU 920, DL PPDU 924, respectively.

In some embodiments, to prioritize LL transmitter, a duration shorter than xIFS channel access, which may be referred to as TP, is used for the LL transmitter to gain channel access and/or then send the NFR 1004, 1006, 1008, where a break between the shorter PPDUs (PPDU, DL PPDU 916, DL PPDU 920, DL PPDU 924) is referred to as TG. The TXOP holder sends frames such as data, TF, block acknowledgements (BA), and so forth, and leaves the breaks. TP 934, 938, 942 is less than TG 918, 922, 926, respectively,

In some examples, the NFR 1004, 1006, 1008, frames can only be sent before the next frame such as the DL PPDUs 916, 920, 924, respectively, sent by the AP 902, which may avoid the hidden node problem between STAs. The STAs 904, 1002 do not preempt other STAs or APs directly, in accordance with some embodiments.

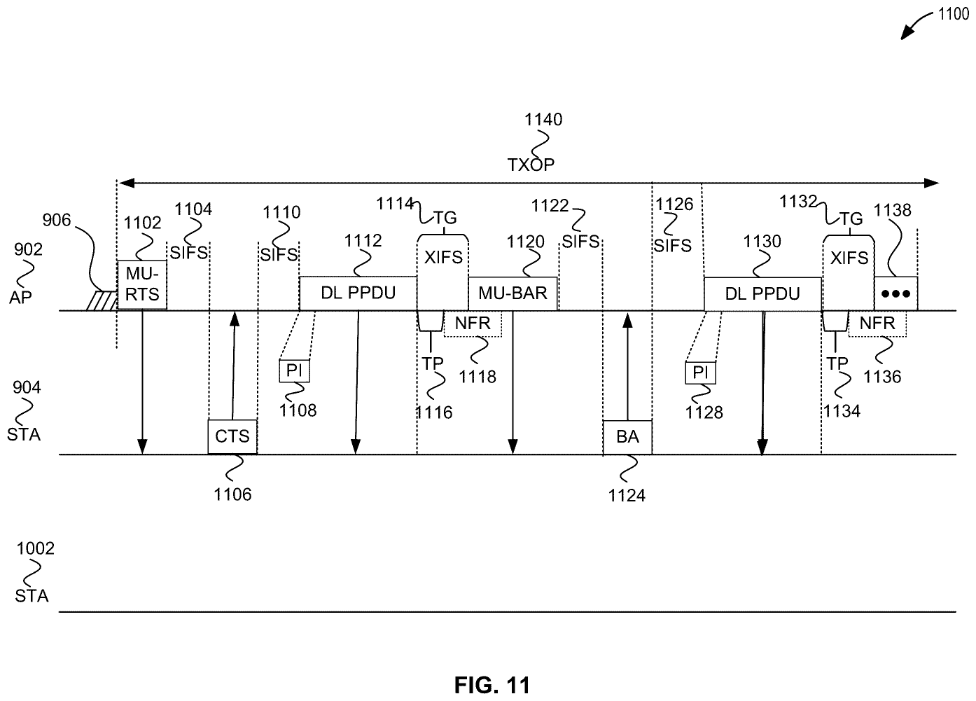

FIG. 11 illustrates a method 1100 for TXOP 1140 preemption for LL applications, in accordance with some embodiments. The method 1100 includes the AP 902 transmitting a multi-user (MU) request-to-send (MU-RTS) 1102. The MU-RTS 1102 indicates an intent by the AP 902 to obtain the TXOP 1140. After a SIFS 1104 duration, the STA 904 transmits a clear-to-send (CTS) 1106. After a SIFS 1110 the AP 902 transmits a DL PPDU 1112. The DL PPDU 1112 may include a PI 1108 or the PI may be indicated another way as disclosed herein. The AP 902 waits a TG 1114, which may be XIFS before transmitting a MU block acknowledgement request (BAR). The LL STA 904 may sense the medium for TP 1116 and determine the medium is available and then transmit a NFR 1118 to indicate that the LL STA 904 has LL communications to send to the AP 902. More than one STA 904 may send NFRs. The resource units or tones for the NFRs 1118 are sent to the STA 904 in a previous frame such as in the DL PPDU 1112, MU-RTS 1102, MU-BAR 1120, a beacon frame (not illustrated), or another DL frame.

The AP 902 may interrupt the TXOP 1140 and transmit a frame to initiate an UL PPDU from one or more the LL STAs. The AP 902 may also complete the TXOP 1140 if TXOP 1140 is nearly over. The STA 904 waits a SIFS 1122 and then transmits a BA 1124 in response to the DL PPDU 1112. There may be more than one STA transmitting BAs.

The TP, e.g., a preemption duration, and the TG, e.g., a wait duration may be one of: short inter-frame space (SIFS), point coordination function (PCF) inter-frame space (PIFS), distributed coordination function (DCF) inter-frame space (DIFS), or another inter-frame space comprising one or more slots.

The AP 902 waits a SIFS 1126 and then transmits another DL PPDU 1130, which is similar to the DL PPDU 1112. The AP 902, in some embodiments, include the PI 1128. The AP 902 waits TG 1132, which here is XIFS and transmits a DL PPDU 1130, which may include PI 1128. The AP waits TG 1132, which here is XIFS, before transmitting 1138. The LL STA 904 senses the medium for a duration of TP 1134 and then transmits NFR 1136 on an RU, which here may be a tone set in a training field of a signal field. The AP 902 receives one or more NFRs 1136 from one or more LL STAs 904 and determines how to respond to the service request from the LL STAs 904, which may be to complete the TXOP 1140 or to interrupt the TXOP 1140 to service the LL STAs 904.

FIG. 11 illustrates a method 1200 for TXOP 1238 preemption for LL applications, in accordance with some embodiments. The AP 902 senses the medium at 1202. The AP 902 then transmits a trigger frame (TF) 1204. The AP 902 then waits a SIFS 1206. The one or more STAs 904 then transmit UL trigger based (TB) PPDU 1208. The AP 902 then waits a SIFS 1210 and transmits a BA 1214 in response to the UL TB PPDU 1208. The AP 902 then waits a TG 1212 duration before transmitting a TF 1220. The BA 1214 or another previous frame may indicate that preemption is permitted. One or more LL STAs 904 wait a TP 1216 duration and then transmit NFRs 1218 on RU assigned in previous frames. The AP 902 determines whether to preempt the TXOP 1238 based on the service requests from the LL STAs 904. One or more STAs 904 wait a SIFS 1222 and then transmit UL TB PPDU 1224 in response to the TF 1220. The TF 1220 may have been generated in response to the NFRs 1218 and include UL RU for the LL STAs 904 to transmit LL frames to the AP 902. The AP 902 waits SIFS 1226 and then transmits BA 1230 in response to the UL TB PPDUs 1224. The method 1200 continues with the AP 902 waiting TG 1228, which may be XIFS, and then transmitting a TF 1236. The LL STAs 904 may sense the medium for a TP 1232 duration and then transmit NFRs 1234. The AP 902 determines how to respond to the NFRs 1234, which may include RUs in the TF 1236 or another way to provide the LL STAs 904 with UL and/or DL RUs to service LL applications within service constraints.

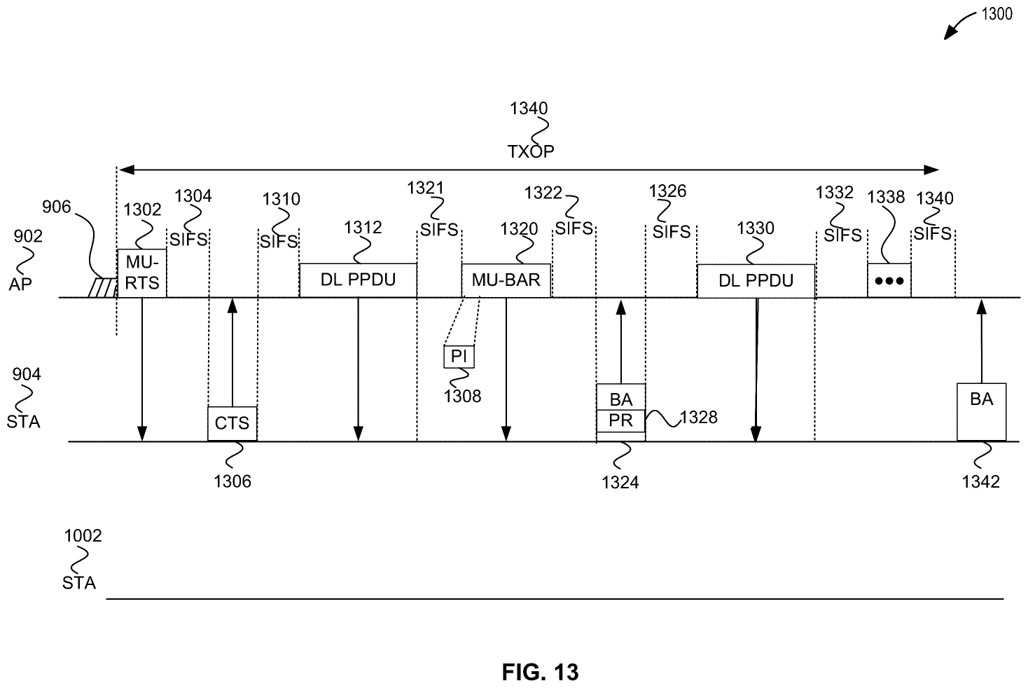

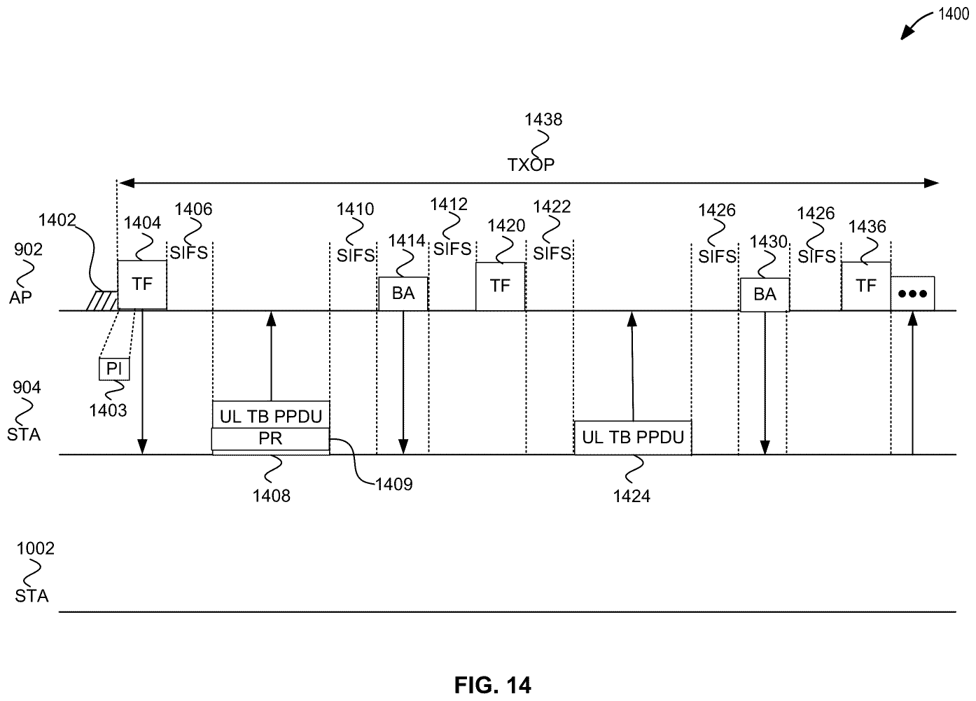

FIG. 13 illustrates a method 1300 for TXOP 1340 preemption for LL applications, in accordance with some embodiments. FIG. 14 illustrates a method 1400 for TXOP 1438 preemption for LL applications, in accordance with some embodiments. FIGS. 13 and 14 are discussed with one another. The AP 902 contends for and obtains the wireless medium at 1402.

One or more LL transmitters, STA 904, can indicate that it has LL packets to send by sending a common PR 1328, PR 1409 control frame over assigned dedicated RU, which is integrated with BA 1324 or UL TB PPDU 1408, respectively, where other STAs 1002 may have RUs within the BA 1324 and UL TB PPDU 1408. The LL transmitters may only send the PR 1328 and PR 1409 if TXOP preemption is allowed, which may be indicated in different ways such as including a PI 1308 or PI 1403 in the MU-BAR 1320 or TF 1404, respectively.

The RU information is preassigned to all the registered LL transmitters or integrated in the preceding PPDU.

Once the AP 902 decodes the PR 1328 frame or PR 1409 frame, the AP 902 may use the following different methods to support the LL packet transmission. The AP 902 can trigger the LL STAs to feedback the LL buffer status using NFRP, then trigger the LL data transmission. AP 902 can trigger the LL STAs to send LL packets with uplink OFDMA-based random-access resource unit. The AP 902 can terminate the TXOP 1340 or TXOP 1438 early. The AP 902 may complete the TXOP 1438 and then support the LL packet transmissions. The AP 902 may support the LL packet transmissions and then continue the TXOP 1340 or TXOP 1438.

FIG. 13 includes a MU-RTS 1302, SIFS 1304, CTS 1306, SIFS 1310, DL PPDU 1312, SIFS 1321, MU-BAR 1320, which here include PI 1308, SIFS 1322, BA 1324, which here include PR 1328, SIFS 1326, DL 1330, SIFS 1332, etcetera 1338, and BA 1342. BA 1342 illustrates that some BA 1342 may not permit the includes of PR 1328. In some embodiments, the PR 1328 includes an indication of the size of the RU the LL station needs to transmit to the AP 902. In some examples, the PI 1308 is included in another frame. For example, the MU-RTS 1302, the DL PPDU 1312, a beacon frame, an association response frame, and so forth. In some embodiments, the PR 1328 may be permitted implicitly by the UL RUs that are assigned to the LL stations in the MU-BAR 1320. In some examples, a configuration such as in a beacon frame indicate which types of frames the LL stations can include a PR 1328 within. FIG. 14 includes TF 1404, PI 1403, SIFS 1406, UL TB PPDU 1408, PR 1409, SIFS 1410, BA 1414, SIFS 1412, TF 1420, SIFS 1422, UL TB PPDU 1424, SIFS 1426, BA 1430, SIFS 1426, TF 1436.

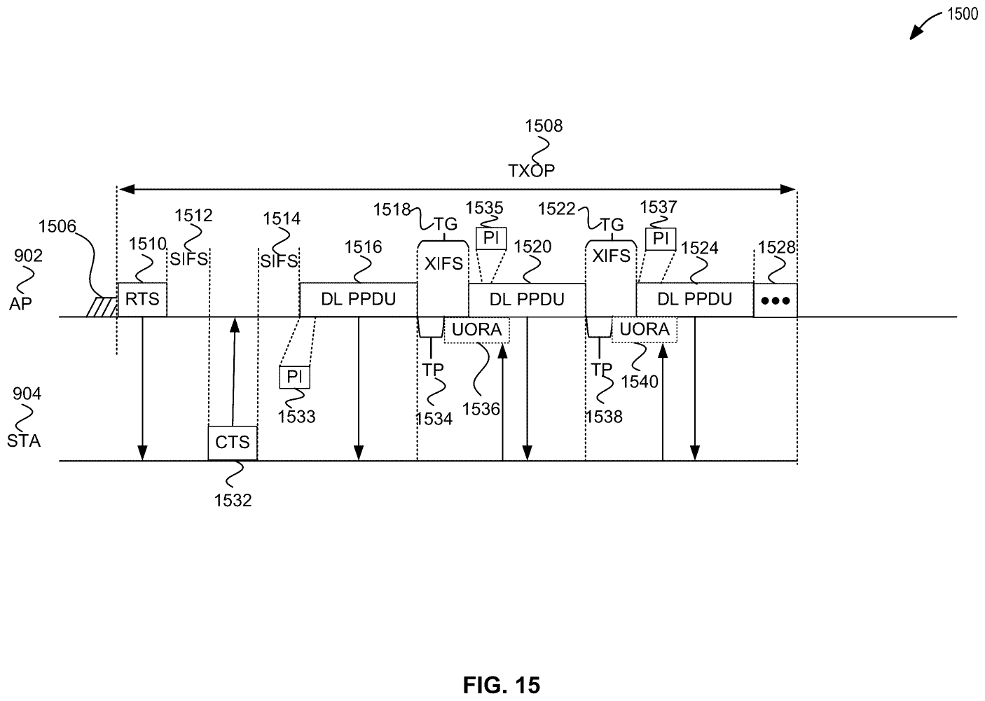

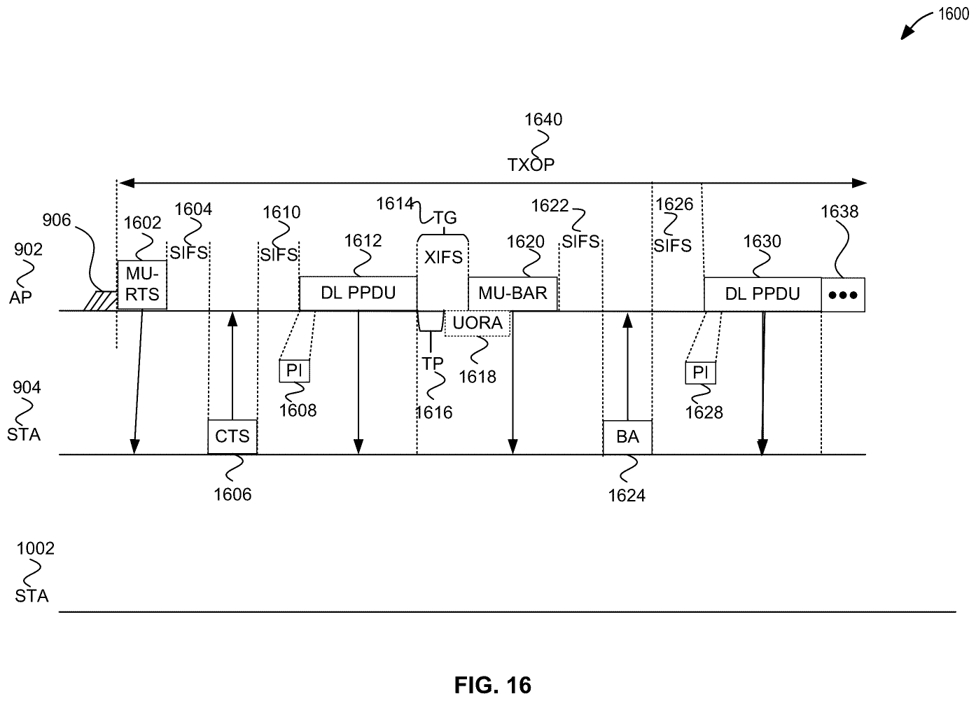

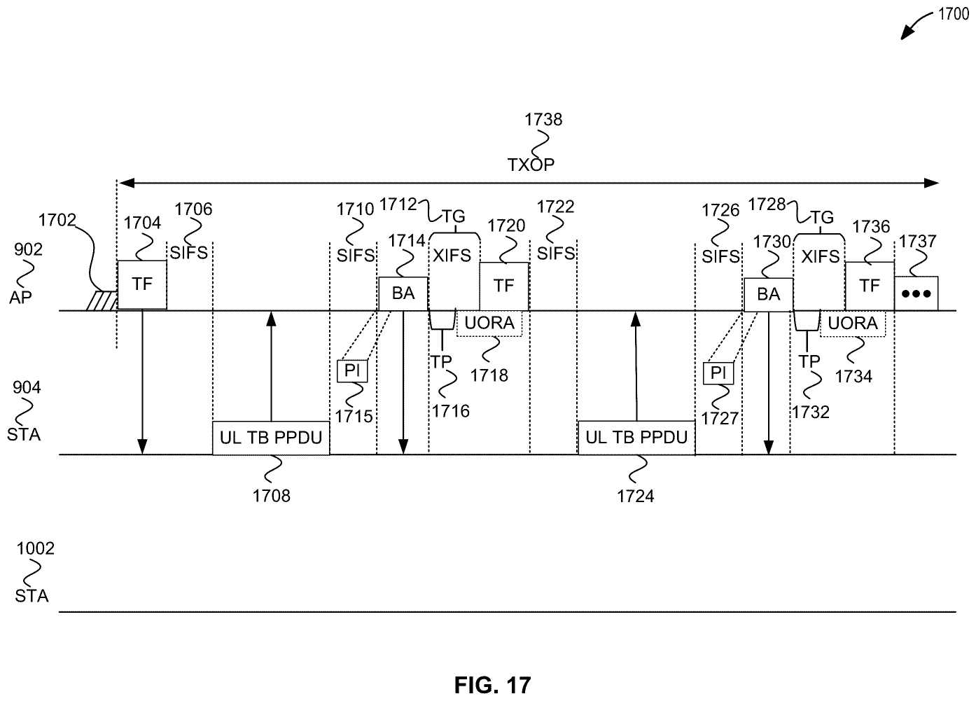

FIG. 15 illustrates a method 1500 for TXOP 1508 preemption for LL applications, in accordance with some embodiments. FIG. 16 illustrates a method 1600 for TXOP 1640 preemption for LL applications, in accordance with some embodiments. FIG. 17 illustrates a method 1700 for TXOP 1738 preemption for LL applications, in accordance with some embodiments. FIGS. 15, 16, and 17 are discussed with one another.

In some embodiments, the first control frame of the TXOP will indicate whether preemption is allowed or not within the TXOP. The Maximum PPDU length will be indicated and updated in the beacon or other management frames sent by the AP regularly.

One or more LL transmitters, e.g., 904 STA, can send LL packet using uplink Orthogonal Frequency Division Multiple Access (OFDMA)-based random access (UORA) 1536, 1540, 1618, 1718, 1734, when preemption is allowed. In some embodiments, the LL transmitter-RU assignment information is preassigned to all the registered LL transmitters, e.g., in a beacon frame, association response, trigger frame, or another frame, or integrated in the preceding PPDU.

To differentiate which time gap within the TXOPs 1508, 1640, 1738, are preemptable or not, PIs 1533, 1535, 1537, 1608, 1628, 1715, 1727, are needed in the PPDU preceding the time gap or in another frame. One bit in U-SIG or UHR-SIG of the preceding PPDU or another frame may indicate whether preemption is allowed TP 1534, 1538, 1616, 1716, 1732, after the end of the preceding PPDU, BA, MU-BAR, or another type of DL frame.

To prioritize LL transmitter, shorter interframe space durations are used, TP 1534, 1538, 1616, 1716, 1732, which here are xIFS. The LL transmitters such as STA 904 can then sense the medium in a shorter time than TG 1518, 1522, 1614, 1712, 1728, which enables the LL transmitter to send UL LL packets to the AP 902 using UORA.

The LL frame can only be sent before the next PPDU sent by the AP to avoid hidden node problem between STAs, so the STA does not preempt the AP 902 directly. UORA 1718 ends before TF 1720 and UORA 1734 would have to end before etcetera 1737. UORA 1536 ends before DL PPDU 1520 and UORA 1540 ends before DL PPDU 1524. UORA 1618 ends before MU-BAR 1620, in accordance with some embodiments.

Upon detection of the preamble of LL packet, e.g., UORA 1536, 1540, 1618, 1718, and 1734, the AP 902 will suspend the following transmission, e.g., DL PPDU 1520, DL PPDU 1524, MU-BAR 1620, TF 1720, and TF 1736, respectively, and resume the TXOP transmission after receiving the LL packet and then transmitting an LL-BA exchange. If the AP 902 did not receive any correct LL packet, it will resume the next packet transmission SIFS time after the end of current LL packet reception, in accordance with some embodiments.

Otherwise, it will resume the next packet transmission SIFS time after the transmission of the BA. The LL transmitters may try to send the LL packet in the next preemptable time gap if it did not receive BA from the AP 902 but the LL transmitters may be limited to a maximum number of preemption opportunities attempts to mitigate the effect to the existing TXOP transmission.

The non-LL STAs or LL STAs may be aware that the transmission of the frame following the PI enabled frame may be delayed due to an UORA transmission.

FIG. 15 includes RTS 1510, SIFS 1512, CTS 1532, SIFS 1514, DL PPDU 1516, TG 1518, DL PPDU 1520, TG 1522, DL PPDU 1524, and etcetera 1528.

FIG. 16 includes MU-RTS 1602, SIFS 1604, CTS 1606, SIFS 1610, DL PPDU 1612, TG 1614, MU-BAR 1620, SIFS 1622, BA 1624, SIFS 1626, DL PPDU 1630, and etcetera 1638. The AP 902 contends for and obtains the wireless medium at 1506.

FIG. 17 includes TF 1704, SIFS 1706, UL TB PPDU 1708, SIFS 1710, BA 1714, TG 1712, TF 1720, SIFS 1722, UL TB PPDU 1724, SIFS 1726, BA 1730, TG 1728, TF 1736, and etcetera 1737. The AP 902 contends for and obtains the wireless medium at 1702.

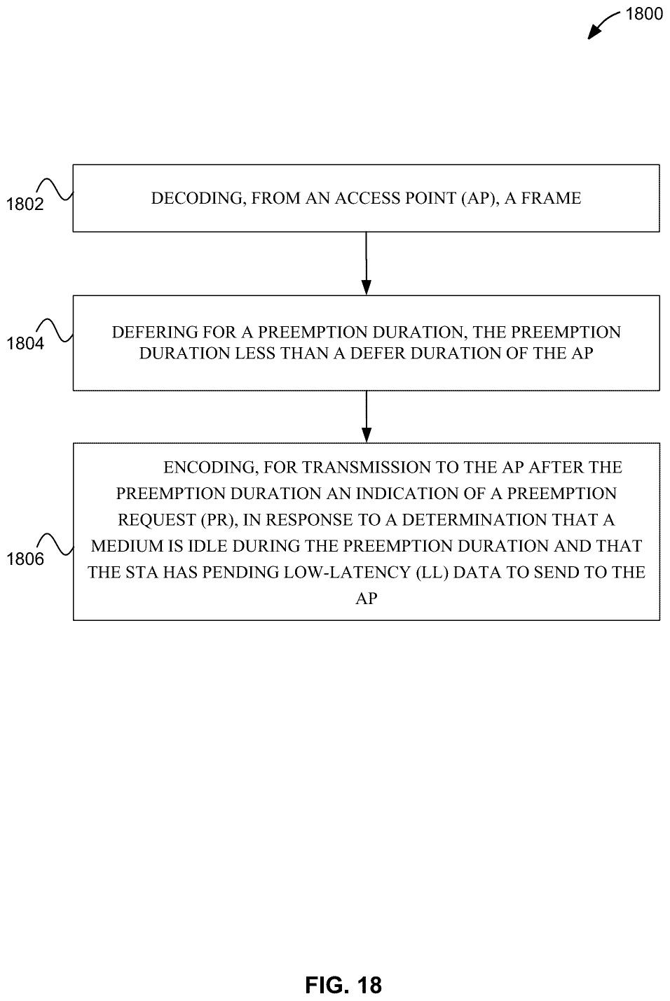

FIG. 18 illustrates a method 1800 for TXOP preemption for LL applications, in accordance with some embodiments. The method 1800 begins at operation 1802 with decoding, from an access point (AP), a frame. For example, STA 904 decodes DL PPDU 916, DL PPDU 920, DL PPDU 1112, DL PPDU 1130, BA 1214, BA 1230, DL PPDU 1516, DL PPDU 1520, DL PPDU 1612, BA 1714, and BA 1730.

The method 1800 continues at operation 1804 with waiting for a preemption duration, the preemption duration less than a defer duration of the AP. For example, the defer duration being TP 934, 938, 942, 1116, 1134, 1216, 1232, 1534, 1538, 1616, 1716, 1732.

The method 1800 continues at operation 1806 with encoding, for transmission to the AP after the preemption duration an indication of a preemption request (PR), in response to a determination that a medium is idle during the preemption duration and that the STA has pending low-latency (LL) data to send to the AP. For example, the STA 904 transmits PR 936, 940, 944, NFR 1004, 1006, 1008, 1118, 1136, 1218, 1234, or UORA 1536, 1540, 1618, 1718, 1734.

The method 1800 may be performed by an apparatus for a STA 504, an apparatus of a non-AP MLD 809, an apparatus of an AP 502, or an apparatus of an AP MLD 808, and/or another device or apparatus disclosed herein. The method 1800 may include one or more additional instructions. The method 1800 may be performed in a different order. One or more of the operations of method 1800 may be optional. PRs are described herein and may be NDPs or other indications of the buffer status of the STAs 904 or indications that the STAs 904 are requesting service for an LL application.

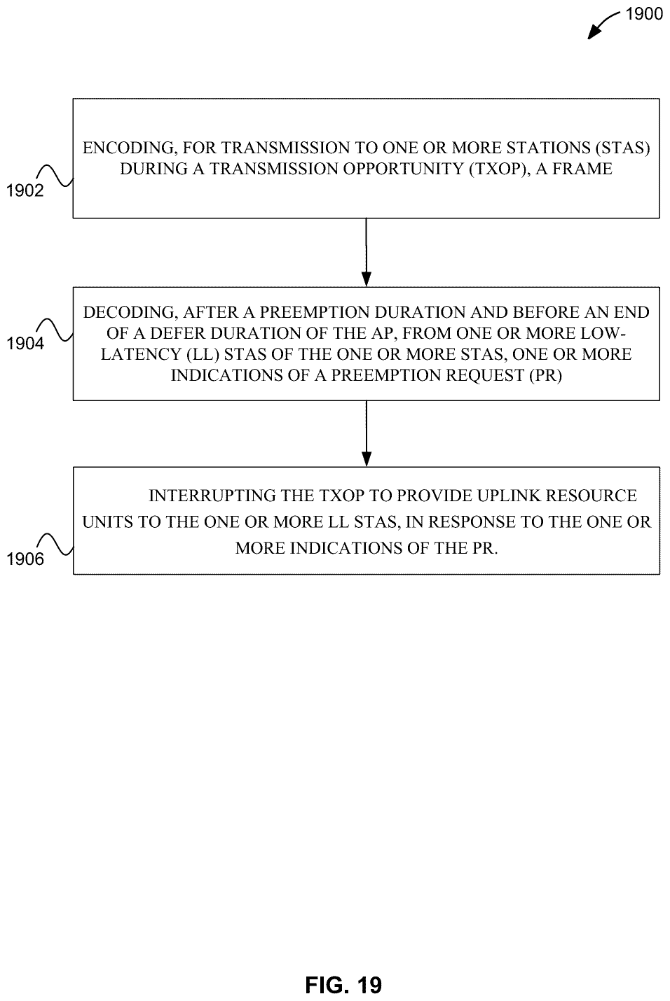

FIG. 19 illustrates a method 1900 for TXOP preemption for LL applications, in accordance with some embodiments. The method 1900 begins at operation 1902 with encoding, for transmission to one or more STAs during a TxOP, a frame. For example, the AP 902 transmits during TXOP 908, 1010, 1140, 1238, 1340, 1438, 1508, 1640, 1738, the frame DL PPDU 916, DL PPDU 920, DL PPDU 1112, DL PPDU 1130, BA 1214, BA 1230, DL PPDU 1516, DL PPDU 1520, DL PPDU 1612, BA 1714, and BA 1730, to the STA 904.

The method 1900 continues at operation 1904 with decoding, after a preemption duration and before an end of a wait duration of the AP, from one or more low-latency (LL) STAs of the one or more STAs, one or more indications of a preemption request (PR). For example, the AP 902 decodes TP 934, 938, 942, 1116, 1134, 1216, 1232, 1534, 1538, 1616, 1716, 1732.

The method 1900 continues at operation 1906 with interrupting the TxOP to provide uplink resource units to the one or more LL STAs, in response to the one or more indications of the PR. For example, as described in conjunction with FIG. 9-17, the AP 902 may interrupt the TxOP, which may mean ending the TxOP, or send frames to solicit uplink traffic from the LL STAs.

The method 1900 may be performed by an apparatus for a STA 504, an apparatus of a non-AP MLD 809, an apparatus of an AP 502, or an apparatus of an AP MLD 808, and/or another device or apparatus disclosed herein. The method 1900 may include one or more additional instructions. The method 1900 may be performed in a different order. One or more of the operations of method 1900 may be optional.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA), the apparatus comprising memory; and processing circuitry coupled to the memory, the processing circuitry configured to:
decode, from an access point (AP), a frame;
wait for a preemption duration, the preemption duration less than a wait duration of the AP; and
encode, for transmission to the AP after the preemption duration an indication of a preemption request (PR), in response to a determination that a medium is idle during the preemption duration and that the STA has pending low-latency (LL) data to send to the AP.

2. The apparatus of claim 1, wherein the preemption duration and the wait duration are each one of: short inter-frame space (SIFS), point coordination function (PCF) inter-frame space (PIFS), distributed coordination function (DCF) inter-frame space (DIFS), or another inter-frame space.

3. The apparatus of claim 1, wherein the PR is completed by an end of the wait duration.

4. The apparatus of claim 1, wherein the indication is a null data packet (NDP) feedback report (NFR) preemption request frame.

5. The apparatus of claim 1, wherein the frame, a beacon frame, an association response frame, a reassociation response frame, a request-to-send frame, a trigger frame, or a multi-user request to send frame, signal field, a ultra-high reliability (UHR) signal field, or an universal signal field, comprises an indication that PRs are permitted.

6. The apparatus of claim 1, wherein the frame is a first frame, and wherein the processing circuitry is further configured to:
decode a second frame, from the AP, the second frame indicating an intent to obtain a transmission opportunity (TxOP); and
encode, for transmission to the AP, a third frame, the third frame in response to the second frame, wherein the first frame is decoded during the TxOP.

7. The apparatus of claim 1, wherein the PR is an Orthogonal Frequency Division Multiple Access (OFDMA)-based random access (UORA), and wherein the processing circuitry is further configured to:
encode, for transmission to the AP on an assigned resource unit, after the preemption duration the indication of the PR, the indication of the PR being a LL frame, the LL frame comprising an LL buffer status of the STA.

8. The apparatus of claim 7, wherein the LL frame comprises a resource request or uplink data.

9. The apparatus of claim 1, wherein the PR is an Orthogonal Frequency Division Multiple Access (OFDMA)-based random access (UORA), and wherein the processing circuitry is further configured to:
encode, for transmission to the AP on a random-access resource unit, after the preemption duration the indication of the PR, the indication of the PR being a LL frame.

10. The apparatus of claim 1, wherein the frame is a first frame, and wherein the processing circuitry is further configured to:
decode, a second frame from the AP before the first frame, the second frame comprising a control frame to obtain an transmission opportunity (TxOP), and the second frame comprising an indication that PR are permitted during the TxOP.

11. The apparatus of claim 1, wherein the processing circuitry is further configured to:
decode, from the AP, a trigger frame, the trigger frame comprising an uplink resource unit for the STA; and
encode, for transmission to the AP, the pending LL data.

12. The apparatus of claim 1, wherein the STA is affiliated with a non-access point (AP) multi-link device (MLD) and the access point is affiliated with an AP MLD.

13. The apparatus of claim 1, further comprising transceiver circuitry coupled to the processing circuitry, wherein the transceiver circuitry is coupled to two or more microstrip antennas for receiving signaling in accordance with a multiple-input multiple-output (MIMO) technique, or the transceiver circuitry is coupled to the processing circuitry, the transceiver circuitry coupled to two or more patch antennas for receiving signaling in accordance with a multiple-input multiple-output (MIMO) technique.

14. A non-transitory computer-readable storage medium including instructions that, when processed by one or more processors, configure an apparatus of a station (STA) to perform operations comprising:
decode, from an access point (AP), a frame, the frame soliciting uplink frames from one or more STAs, the one or more STAs comprising the STA; and
in response to a determination that the STA has pending low-latency (LL) data to send to the AP, encode, for transmission to the AP, an indication of a preemption request (PR) on a dedicated resource unit for PRs.

15. The non-transitory computer-readable storage medium of claim 14, wherein the indication of the PR is a common PR control frame.

16. The non-transitory computer-readable storage medium of claim 14, wherein a block acknowledgement or an uplink (UL) trigger-based physical layer protocol data unit (UL TB PPDU) comprises the dedicated resource unit for PRs.

17. An apparatus for an access point (AP), the apparatus comprising memory; and processing circuitry coupled to the memory, the processing circuitry configured to:
encode, for transmission to one or more stations (STAs) during a transmission opportunity (TxOP), a frame;
decode, after a preemption duration and before an end of a wait duration of the AP, from one or more low-latency (LL) STAs of the one or more STAs, one or more indications of a preemption request (PR); and
interrupt the TxOP to provide uplink resource units to the one or more LL STAs, in response to the one or more indications of the PR.

18. The apparatus of claim 17, wherein the preemption duration and the wait duration are each one of: short inter-frame space (SIFS), point coordination function (PCF) inter-frame space (PIFS), distributed coordination function (DCF) inter-frame space (DIFS), or another inter-frame space.

19. The apparatus of claim 17, wherein the one or more indications are null data packet (NDP) feedback report (NFR) preemption request frames or Orthogonal Frequency Division Multiple Access (OFDMA)-based random access (UORA) frames.

20. The apparatus of claim 17, wherein the frame is a first frame, and wherein the processing circuitry is further configured to:
encode a second frame, the second frame indicating that the one or more indications of the PR are permitted, wherein the second frame is one of: a beacon frame, an association response frame, a reassociation response frame, a request-to-send frame, a trigger frame, or a multi-user request to send frame, signal field, a ultra-high reliability (UHR) signal field, or an universal signal field, comprises an indication that PRs are permitted.
